(19) United States
(12) Patent Application Publication
(10) Pub. No.: US 2006/0202948 A1
(43) Pub. Date: Sep. 14, 2006

(54) Electrophoretic display panel

(75) Inventors: Mark Thomas Johnson, Eindhoven (NL); Neculai Ailenei, Heerlen (NL); Guofu Zhou, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/564,382

(22) PCT Filed: Jul. 8, 2004
(86) PCT No.: PCT/IB04/51171

§ 371 Date: Jan. 12, 2006

(30) Foreign Application Priority Data
Jul. 15, 2003 (EP) 03102155.3

(51) Int. Cl. G09G 3/34

(52) U.S. Cl. 345/107

(57) ABSTRACT

An electrophoretic display panel (1) comprises: an electrophoretic medium (5) comprising charged particles (6); a plurality of picture elements (2); electrodes (3,4) associated with each picture element (2) for receiving a potential difference; and drive means (100). The drive means (100) are arranged for application of a grey scale potential difference to enable the particles (6) to occupy the position corresponding to the image information. The drive means are further arranged for application of grey scale potential differences during an update period to only a sub-assembly of the picture elements of the display, without addressing the remainder of the picture elements of the display during said update period. More grey scales are obtained.

The invention relates to an electrophoretic display panel, comprising:
an electrophoretic medium comprising charged particles;
a plurality of picture elements;
electrodes associated with each picture element for receiving a potential difference; and
drive means,
   the drive means being arranged for controlling the potential difference of each of the plurality of picture elements to be a grey scale potential difference during update periods for enabling the particles to occupy a position corresponding to grey scale data.

The invention also relates to a method for driving such an electrophoretic display panel.

The invention further relates to drive means for driving such an electrophoretic display panel.

The invention also relates to a method for driving an electrophoretic display device in which method grey scale data are applied to a plurality of picture elements.

A display device of the type mentioned in the opening paragraph is known from the international patent application WO 99/53373. This patent application discloses an electronic ink display comprising two substrates, one of which is transparent, the other substrate is provided with electrodes arranged in row and columns. A crossing between a row and a column electrode is associated with a display element. The display element is coupled to the column electrode via a thin film transistor (TFT), the gate of which is coupled to the row electrode. This arrangements of display elements, TFT transistors and row and column electrode together forms an active matrix. Furthermore, the display element comprises a pixel electrode. A row driver selects a row of display elements and the column driver supply a data signal to the selected row of display elements via the column electrodes and the TFT transistors. The data signals corresponds to graphic data to be displayed.

Furthermore, an electronic ink is provided between the pixel electrode and a common electrode provided on the transparent substrate. The electronic ink comprises multiple microcapsules, of about 10 to 50 microns. Each microcapsule comprises positively charged white particles and negatively charge black particles suspended in a fluid. When a positive voltage is applied to the pixel electrode, the white particles move to the side of the micro capsule directed to the transparent substrate and the display element becomes visible to a viewer. Simultaneously, the black particles move to the pixel electrode at the opposite side of the microcapsule where they are hidden to the viewer. By applying a negative voltage to the pixel electrode, the black particles move to the common electrode at the side of the micro capsule directed to the transparent substrate and the display element appears dark to a viewer. When the electric field is removed the display device remains in the acquired state and exhibit a bi-stable character.

Grey scales can be created in the display device by controlling the amount of particles that move to a counter electrode e.g. at the top of microcapsules. For example, the energy of the positive or negative electric field, defined as the product of field strength and time of application, controls the amount of particles moving to the top of the microcapsules. Thus the device has drive means that are arranged for controlling the potential difference of each of the plurality of picture elements to be a grey scale potential difference for enabling the particles to occupy a position corresponding to the grey scale data, i.e. the image information.

The image displayed on the device is updated when a new image is to be displayed. During the update period the grey scales are set.

Within the concept of the invention “grey scale” and “grey scale data” is to be broadly interpreted as any position or situation in between extreme state, i.e. in between a first extreme state (e.g. white or black or a particular color) and a second extreme state (e.g. black or white or another particular color).

A problem that is encountered in electrophoretic devices is that the number of grey scales achievable are limited by the number of grey scale driving voltages available and the length of the driving time periods (as the particles move according to the product of applied voltage×time). The drive time is given by an integral number of frame periods, as each pixel can only be updated once per frame. Whilst it may be possible to reduce the frame time by operating the entire system at higher frequencies (at the cost of an increased power dissipation), in general the driving electronics will provide practical limits to how far this is possible (especially maximum operating frequencies of column drivers, charging time of addressing thin film transistors and delay times along addressing lines). The number of driving voltages (i.e. the available different driving voltages) is often also limited, e.g. −aV, 0, +aV where a is a fixed value. Using a variable driving voltage could increase the number of grey levels, however at the cost of a more complex driving circuit and the risk of variations in the driving voltage leading to variations in grey level.

Thus it is an object to enable an increase in the number of grey levels in an alternative manner.

The object is thereby achieved that the drive means are further arranged for application of grey scale potential differences during an update period at only a sub-assembly of the picture elements of the display, without addressing the remainder of the picture elements of the display during said update period.

The invention is based on the insight that updating only a sub-assembly of the picture element, instead of the whole display, without addressing the remainder of the picture elements is possible with electrophoretic displays because at the not-updated parts of the display (i.e. those picture elements that are not-updated) the previous image will remain in place as the effect is bi-stable. By updating only a portion of the picture element, the frame time becomes shorter (because the frame itself becomes smaller) and consequently, with the same driving voltage, more grey scales can be set. E.g. if a full extremum-to-extremum (black-to-white or white-to-black or more generally first color-to second color) requires a drive of 3000 Volt.msec, and the frame time is 20 msec and the magnitude of the drive voltage is 15V, then the maximum number of grey levels is equal to 3000/15*20=10. The frame time is determined amongst others by the time needed to update a frame. By using a partial image update, the frame time can be reduced (e.g. by a factor of two, if only the bottom or lower half of the display is updated). In such circumstances the frame time may be cut in half to 10 msec, increasing the number of grey levels to 3000/15*10=20.

In a first embodiment of the invention the drive means are further arranged for application of grey scale potential differences at only a portion of the display, i.e. a specific area of the display.

In these embodiments a specific area (e.g. the upper half, the lower half or a window) within the image is updated during one update period.

This embodiment, without being necessarily restricted to the below discussed situations, is in particular advantageous in situations which are frequently encountered when for example web browsing, or using other windows related applications. Often, there is one “active window”, i.e. a window in which the image information is changing, whereas the rest of the image is static, i.e. without any change in image. Addressing the picture elements in only the active window, enables the frame time to be reduced, e.g. twice as often in the same period of time i.e. when frame time resolution is halved, and thus more voltage pulses with different lengths can be applied and hence more grey levels obtained, and such is achieved without increasing the operating frequency of the overall system, and without creating additional artefacts. An added positive effect is that the parts of the image that are changing (the “active window”), which are most likely those of most interest to which the intention of the viewer is drawn, have optimal grey scales. It is remarked however, that, although in preferred embodiments the portion of the display corresponding to an window displayed on the display, “window” meaning a part of the display on which an image distinguishable from the image on the rest of the display is meant, the above described embodiment may also be applied for updating “portion-by-portion” a larger image, covering the whole of the display screen.

In a second embodiment the drive means are arranged for application of grey scale potential differences in an interlaced manner.

Whilst the first embodiment (updating “portion-by-portion”) is straight forward to implement, it may result in a perception artefact in that a portion, e.g. the top half, of the display will (temporarily) appear to contain more grey levels (i.e. pictures will appear more natural) than the bottom half. In particular, a clear boundary may be apparent in the image between the top and bottom blocks. In order to avoid this problem, in a preferred embodiment subsets of rows are chosen in any of the known interlaced manners (for example with one subset comprising all even numbered rows and one all odd numbered rows) and the grey scale differences are applied in an interlaced manner.

In further embodiments the drive means are arranged for application of a grey scale potential difference to all of the picture elements to drive each picture element to a position corresponding to or close to a position corresponding to the grey scale data, and for separate application of grey scale potential differences at only a sub-assembly of the picture elements of the display, without addressing the remainder of the picture elements of the display.

In these embodiments all picture elements are, using the known driving method, driven to a position close to or corresponding to the wanted grey scale, i.e. a full screen update. Thereafter (or prior) addressing of only some of the picture elements (i.e. a partial update with a shorter frame time) is performed, i.e. a partial screen update with a shorter frame time. To those elements that already have the correct grey scale no voltage is applied, to those that need a small additional grey scale a driving voltage is applied. The advantage over the previous embodiment is that a smoother image update is achieved.

Although the partial update could be done prior to or after full screen update, it is preferred that it is done afterwards, since a smoother image update is achieved.

Preferably, before application of new image data, the picture elements are reset to an extreme state, e.g. to a black or a white state, i.e. the drive means are arranged for application of reset potential differences.

Resetting the picture elements to one of the extreme states requires for different picture elements the application of a reset potential. The total duration of the application of the reset potential difference is best made a function of the difference between the grey scale before resetting and the extreme state to which the picture elements is to be reset, i.e. when a picture element which is white has to be reset to a black state the reset potential difference is applied during a relatively long time period, whereas if a picture element is to be reset from a dark grey to a black state, the reset potential difference need only to be applied for a relatively shorter time period.

In accordance with the present invention, there is provided a method for driving an electrophoretic display device comprising: an electrophoretic medium (5) comprising charged particles (6);
a plurality of picture elements (2), in which method grey scale data pulses are applied to elements of the display device during an update period, is, in accordance with the invention characterized in that the grey scale data pulses are applied to a sub-assembly of the picture elements, without updating the remainder of the picture elements.

In preferred embodiments the grey scale data pulses are applied portion-for-portion of the display panel. In different preferred embodiments the grey scale date pulses are applied in an interlaced manner.

Also in accordance with the present invention, there is provided drive means for driving an electrophoretic display panel, said display panel comprising:

an electrophoretic medium comprising charged particles;

a plurality of picture elements; and

electrodes associated with each picture element for receiving a potential difference; said drive means being arranged for controlling the potential difference of each picture element to be a grey scale potential difference for enabling the particles to occupy the position corresponding to the image information,

said drive means being further arranged for application of grey scale potential differences during an update period to only a sub-assembly of the picture elements of the display, without addressing the remainder of the picture elements of the display during said update period.

These and other aspects of the display panel of the invention will be further elucidated and described with reference to the drawings, in which:

FIG. 1 shows diagrammatically a front view of an embodiment of the display panel;

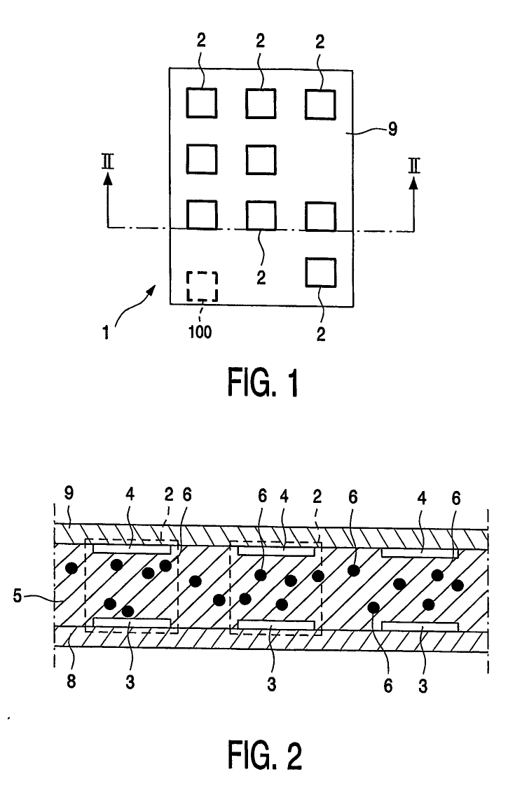

FIG. 2 shows diagrammatically a cross-sectional view along II-II in FIG. 1;

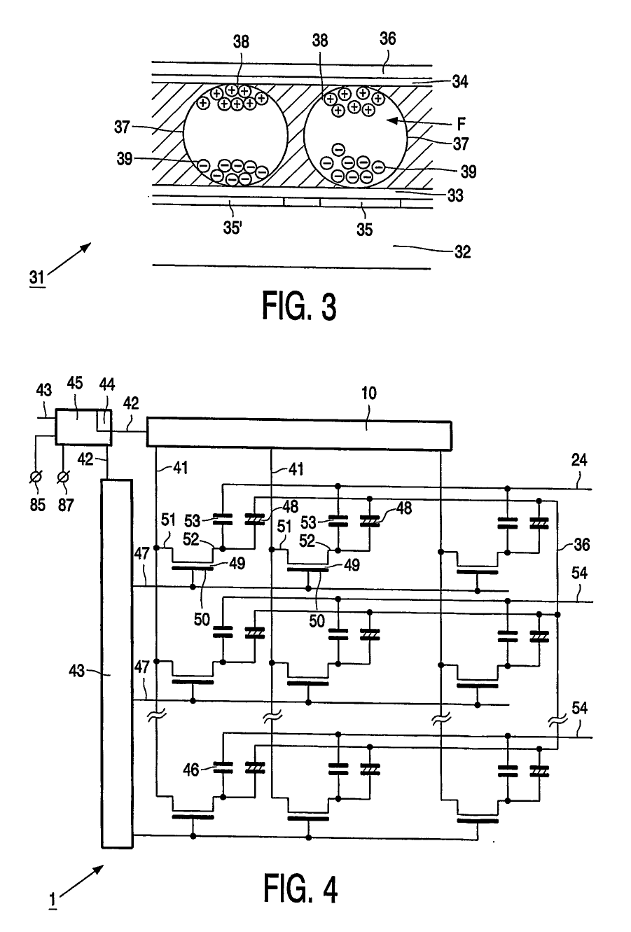

FIG. 3 shows diagrammatically a cross section of a portion of a further example of an electrophoretic display device;

FIG. 4 shows diagrammatically an equivalent circuit of a picture display device of FIG. 3;

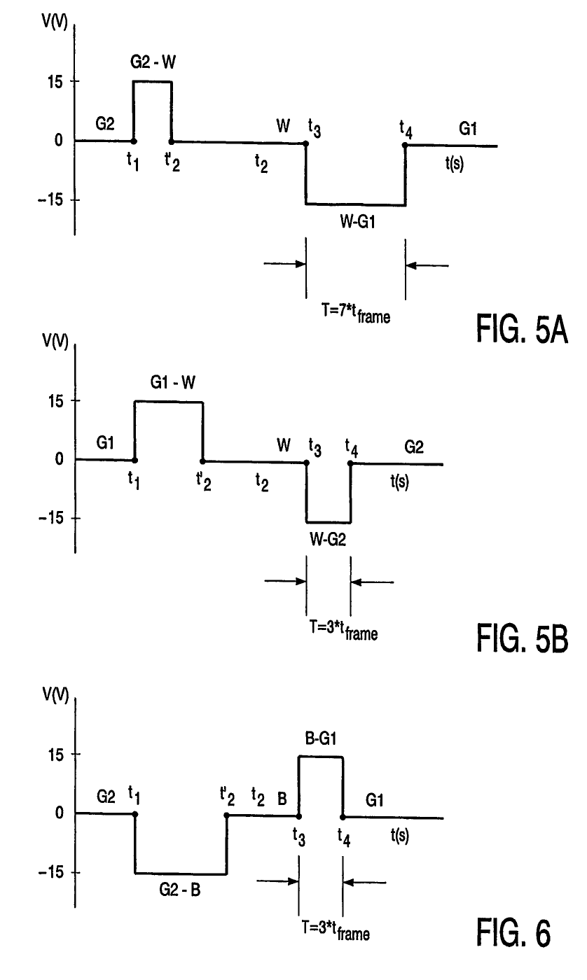

FIG. 5A shows diagrammatically the potential difference as a function of time for a picture element of the subset for the embodiment;

FIG. 5B shows diagrammatically the potential difference as a function of time for a picture element of the subset in a variation of the embodiment;

FIG. 6A shows diagrammatically the potential difference as a function of time for a picture element of the subset in another variation of the embodiment;

FIG. 6B shows diagrammatically the potential difference as a function of time for another picture element of the subset in the same variation of the embodiment associated with FIG. 5A;

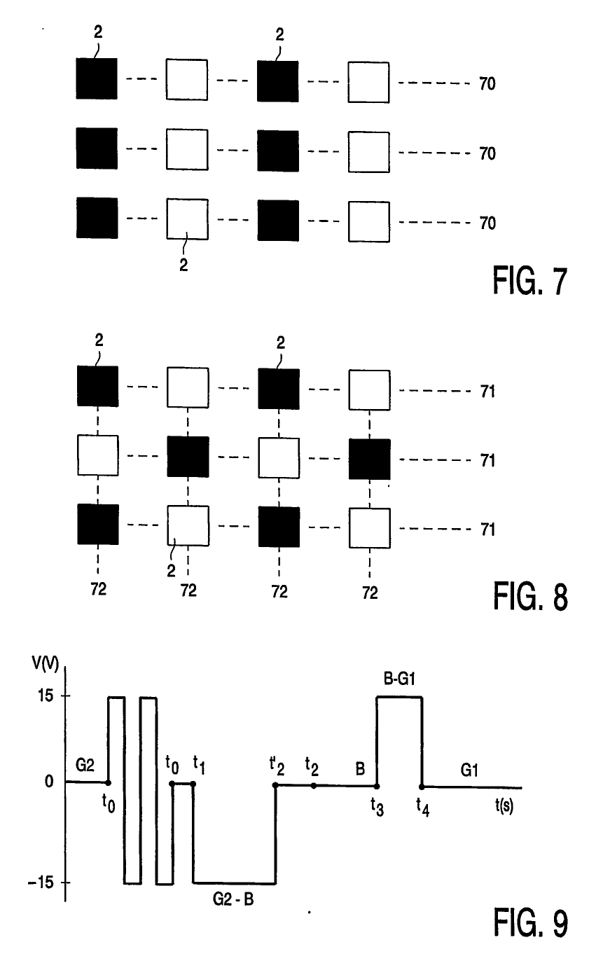

FIG. 7 shows the picture representing an average of the first and the second appearances as a result of the reset potential differences in another variation of the embodiment, and

FIG. 8 shows the picture representing an average of the first and the second appearances as a result of the reset potential differences in another variation of the embodiment.

FIG. 9 shows diagrammatically the potential difference as a function of time for a picture element of the subset in another variation of the embodiment.

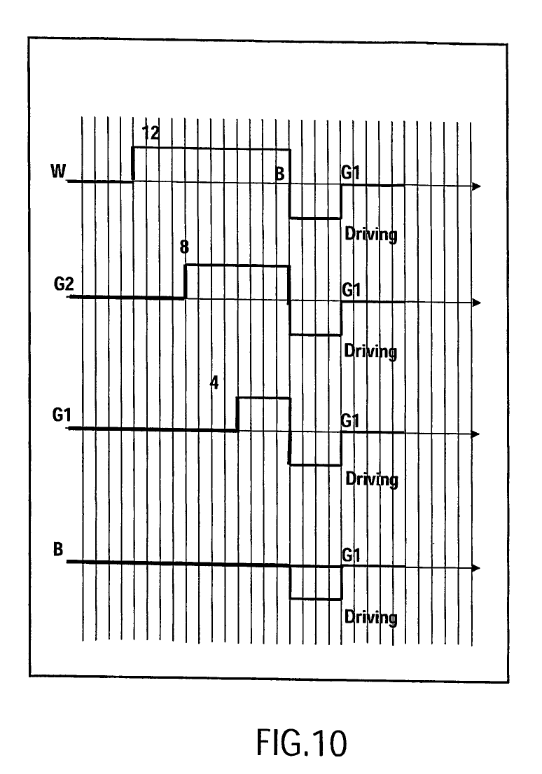

FIG. 10 shows in detail that the reset pulse as well as the driving or grey scale data pulse is an integral number times the frame time.

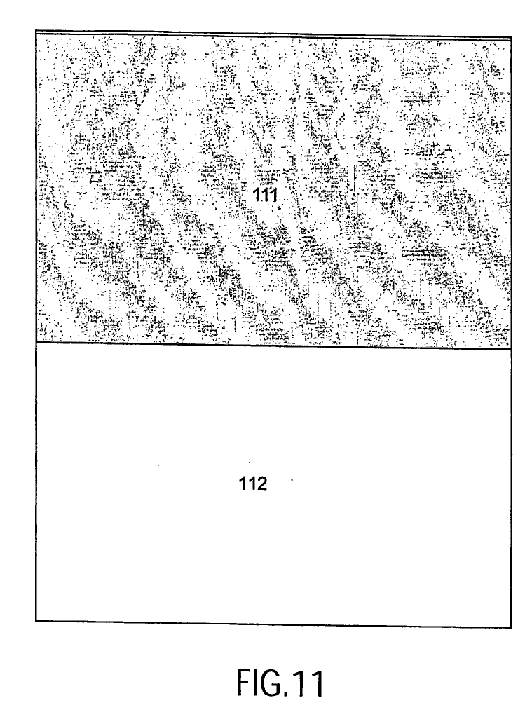

FIG. 11 illustrates an embodiment of the invention.

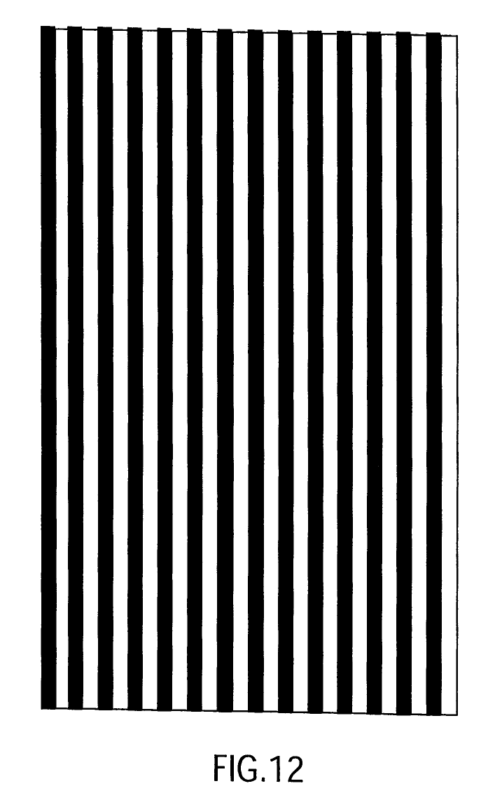

FIG. 12 illustrates yet a further embodiment of the invention.

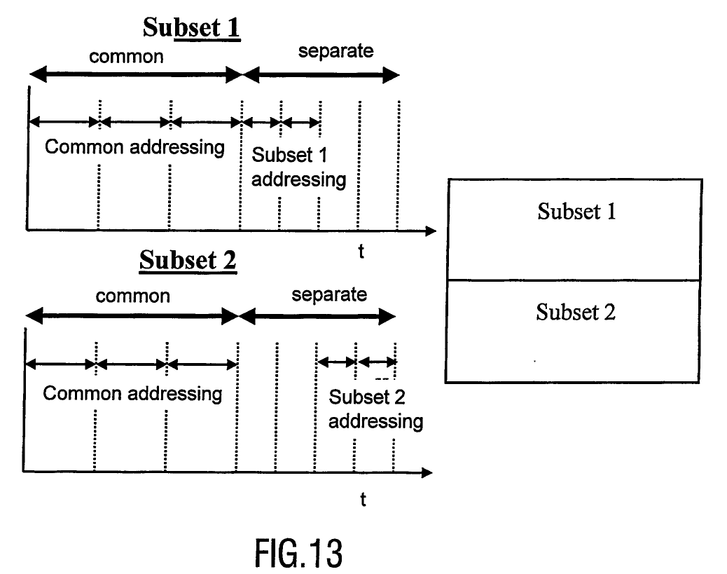

FIG. 13 illustrates a further embodiment of the invention.

In all the Figures corresponding parts are usually referenced to by the same reference numerals.

FIGS. 1 and 2 show an embodiment of the display panel 1 having a first substrate 8, a second opposed substrate 9 and a plurality of picture elements 2. Preferably, the picture elements 2 are arranged along substantially straight lines in a two-dimensional structure. Other arrangements of the picture elements 2 are alternatively possible, e.g. a honeycomb arrangement. An electrophoretic medium 5, having charged particles 6, is present between the substrates 8,9. A first and a second electrode 3,4 are associated with each picture element 2. The electrodes 3, 4 are able to receive a potential difference. In FIG. 2 the first substrate 8 has for each picture element 2 a first electrode 3, and the second substrate 9 has for each picture element 2 a second electrode 4. The charged particles 6 are able to occupy extreme positions near the electrodes 3,4 and intermediate positions in between the electrodes 3,4. Each picture element 2 has an appearance determined by the position of the charged particles 6 between the electrodes 3,4 for displaying the picture. Electrophoretic media 5 are known per se from e.g. U.S. Pat. No. 5,961,804, U.S. Pat. No. 6,120,839 and U.S. Pat. No. 6,130,774 and can e.g. be obtained from E Ink Corporation. As an example, the electrophoretic medium 5 comprises negatively charged black particles 6 in a white fluid. When the charged particles 6 are in a first extreme position, i.e. near the first electrode 3, as a result of the potential difference being e.g. 15 Volts, the appearance of the picture element 2 is e.g. white. Here it is considered that the picture element 2 is observed from the side of the second substrate 9. When the charged particles 6 are in a second extreme position, i.e. near the second electrode 4, as a result of the potential difference being of opposite polarity, i.e. −15 Volts, the appearance of the picture element 2 is black. When the charged particles 6 are in one of the intermediate positions, i.e. in between the electrodes 3,4, the picture element 2 has one of the intermediate appearances, e.g. light gray, middle gray and dark gray, which are gray levels between white and black. The drive means 100 are here arranged for controlling the potential difference of each picture element 2 to be a reset potential difference having a reset value and a reset duration for enabling particles 6 to substantially occupy one of the extreme positions, and subsequently to be a grey scale potential difference for enabling the particles 6 to occupy the position corresponding to the image information.

FIG. 3 diagrammatically shows a cross section of a portion of a further example of an electrophoretic display device 31, for example of the size of a few display elements, comprising a base substrate 32, an electrophoretic film with an electronic ink which is present between two transparent substrates 33, 34 for example polyethylene, one of the substrates 33 is provided with transparent picture electrodes 35 and the other substrate 34 with a transparent counter electrode 36. The electronic ink comprises multiple micro capsules 37, of about 10 to 50 microns. Each micro capsule 37 comprises positively charged white particles 38 and negative charged black particles 39 suspended in a fluid F. When a positive field is applied to the pixel electrode 35, the white particles 38 move to the side of the micro capsule 37 directed to the counter electrode 36 and the display element become visible to a viewer. Simultaneously, the black particles 39 move to the opposite side of the microcapsule 37 where they are hidden to the viewer. By applying a negative field to the pixel electrodes 35, the black particles 39 move to the side of the micro capsule 37 directed to the counter electrode 36 and the display element become dark to a viewer (not shown). When the electric field is removed the particles 38, 39 remains in the acquired state and the display exhibits a bi-stable character and consumes substantially no power.

FIG. 4 shows diagrammatically an equivalent circuit of a picture display device 31 comprising an electrophoretic film laminated on a base substrate 32 provided with active switching elements, a row driver 46 and a column driver 40. Preferably, a counter electrode 36 is provided on the film comprising the encapsulated electrophoretic ink, but could be alternatively provided on a base substrate in the case of operation using in-plane electric fields. The display device 31 is driven by active switching elements, in this example thin film transistors 49. It comprises a matrix of display elements at the area of crossing of row or selection electrodes 47 and column or data electrodes 41. The row driver 46 consecutively selects the row electrodes 47, while a column driver 40 provides a data signal to the column electrode 41. Preferably, a processor 45 firstly processes incoming data 43 into the data signals. Mutual synchronization between the column driver 40 and the row driver 46 takes place via drive lines 42. Select signals from the row driver 46 select the pixel electrodes 42 via the thin film transistors 49 whose gate electrodes 50 are electrically connected to the row electrodes 47 and the source electrodes 51 are electrically connected to the column electrodes 41. A data signal present at the column electrode 41 is transferred to the pixel electrode 52 of the display element coupled to the drain electrode via the TFT. In the embodiment, the display device of FIG. 3 also comprises an additional capacitor 53 at the location at each display element 48. In this embodiment, the additional capacitor 53 is connected to one or more storage capacitor lines 54. Instead of TFT other switching elements can be applied such as diodes, MIM's, etc.

As an example the appearance of a picture element of a subset is light gray, denoted as G2, before application of the reset potential difference. Furthermore, the picture appearance corresponding to the image information of the same picture element is dark gray, denoted as G1. For this example, the potential difference of the picture element is shown as a function of time in FIG. 5A. The reset potential difference has e.g. a value of 15 Volts and is present from time t₁ to time t′₂, t₂ being the maximum reset duration. The reset duration and the maximum reset duration e.g. 60 ms and 300 ms, respectively. As a result the picture element has an appearance being substantially white, denoted as W. The grey scale potential difference is present from time t₃ to time t₄ and has a value of e.g. −15 Volts and a duration of e.g. 140 ms. As a result the picture element has an appearance being dark gray (G1), for displaying the picture. The interval from time t2 to time t3 may be absent. The application time T in which the grey scale potential difference may be applied is an integral number times the frame time. In this example the frame time is 20 ms, so T=7*t_{frame}.

The maximum reset duration, i.e. the complete reset period, for each picture element of the subset is substantially equal to or more than the duration to change the position of particles 6 of the respective picture element from one of the extreme positions to the other one of the extreme positions. For the picture element in the example the reference duration is e.g. 300 ms.

As a further example the potential difference of a picture element is shown as a function of time in FIG. 5B. The appearance of the picture element is dark gray (G1) before application of the reset potential difference. Furthermore, the picture appearance corresponding to the image information of the picture element is light gray (G2). The reset potential difference has e.g. a value of 15 Volts and is present from time t₁ to time t′₂. The reset duration is e.g. 140 ms. As a result the picture element has an appearance being substantially white (W). The grey scale potential difference is present from time t3 to time t4 and has e.g. a value of e.g. −15 Volts and a duration of e.g. 60 ms. As a result the picture element has an appearance being light gray (G2), for displaying the picture.

In another variation of the embodiment the drive means 100 are further arranged for controlling the reset potential difference of each picture element to enable particles 6 to occupy the extreme position which is closest to the position of the particles 6 which corresponds to the image information. As an example the appearance of a picture element is light gray (G2) before application of the reset potential difference. Furthermore, the picture appearance corresponding to the image information of the picture element is dark gray (G1). For this example, the potential difference of the picture element is shown as a function of time in FIG. 6A. The reset potential difference has e.g. a value of −1 S Volts and is present from time t₁ to time t′₂. As a result, the particles 6 occupy the second extreme position and the picture element has a substantially black appearance, denoted as B, which is closest to the position of the particles 6 which corresponds to the image information, i.e. the picture element 2 having a dark gray appearance (G1). The grey scale potential difference is present from time t3 to time t4 and has e.g. a value of e.g. 15 Volts and a duration of e.g. 60 ms. As a result the picture element 2 has an appearance being dark gray (G1), for displaying the picture.

In FIG. 7 the picture elements are arranged along substantially straight lines 70. The picture elements have substantially equal first appearances, e.g. white, if particles 6 substantially occupy one of the extreme positions, e.g. the first extreme position. The picture elements have substantially equal second appearances, e.g. black, if particles 6 substantially occupy the other one of the extreme positions, e.g. the second extreme position. The drive means are further arranged for controlling the reset potential differences of subsequent picture elements 2 along each line 70 to enable particles 6 to substantially occupy unequal extreme positions. FIG. 7 shows the picture representing an average of the first and the second appearances as a result of the reset potential differences. The picture represents substantially middle gray.

In FIG. 8 the picture elements 2 are arranged along substantially straight rows 71 and along substantially straight columns 72 being substantially perpendicular to the rows in a two-dimensional structure, each row 71 having a predetermined first number of picture elements, e.g. 4 in FIG. 8, each column 72 having a predetermined second number of picture elements, e.g. 3 in FIG. 8. The picture elements have substantially equal first appearances, e.g. white, if particles 6 substantially occupy one of the extreme positions, e.g. the first extreme position. The picture elements have substantially equal second appearances, e.g. black, if particles 6 substantially occupy the other one of the extreme positions, e.g. the second extreme position. The drive means are further arranged for controlling the reset potential differences of subsequent picture elements 2 along each row 71 to enable particles 6 to substantially occupy unequal extreme positions, and the drive means are further arranged for controlling the reset potential differences of subsequent picture elements 2 along on each column 72 to enable particles 6 to substantially occupy unequal extreme positions. FIG. 8 shows the picture representing an average of the first and the second appearances as a result of the reset potential differences. The picture represents substantially middle gray, which is somewhat smoother compared to the previous embodiment.

In variations of the device the drive means are further arranged for controlling the potential difference of each picture element to be a sequence of preset potential differences before being the reset potential difference. Preferably, the sequence of preset potential differences has preset values and associated preset durations, the preset values in the sequence alternate in sign, each preset potential difference represents a preset energy sufficient to release particles 6 present in one of the extreme positions from their position but insufficient to enable said particles 6 to reach the other one of the extreme positions. As an example the appearance of a picture element is light gray before the application of the sequence of preset potential differences. Furthermore, the picture appearance corresponding to the image information of the picture element is dark gray. For this example, the potential difference of the picture element is shown as a function of time in FIG. 9. In the example, the sequence of preset potential differences has 4 preset values, subsequently 15 Volts, −15 Volts, 15 Volts and −15 Volts, applied from time t₀ to time t′₀. Each preset value is applied for e.g. 20 ms. The time interval between t′₀ and t₁ is preferably relatively small. Subsequently, the reset potential difference has e.g. a value of −15 Volts and is present from time t₁ to time t′₂. The reset duration is e.g. 160 ms. As a result, the particles 6 occupy the second extreme position and the picture element has a substantially black appearance. The grey scale potential difference is present from time t₃ to time t₄ and has e.g. a value of e.g. 15 Volts and a duration of e.g. 60 ms. As a result the picture element 2 has an appearance being dark gray, for displaying the picture. Without being bound to a particular explanation for the mechanism underlying the positive effects of application of the preset pulses, it is presumed that the application of the preset pulses increases the momentum of the electrophoretic particles and thus shortens the switching time, i.e the time necessary to accomplish a switch-over, i.e. a change in appearance. It is also possible that after the display device is switched to a predetermined state e.g. a black state, the electrophoretic particles are “frozen” by the opposite ions surrounding the particle. When a subsequent switching is to the white state, these opposite ions have to be timely released, which requires additional time. The application of the preset pulses, sometimes also called “shaking pulses” speeds up the release of the opposite ions thus the de-freezing of the electrophoretic particles and therefore shortens the switching time. The application of shaking pulses prior to application of the reset pulse, and/or prior to application of the drive pulse (grey scale data pulse) is within embodiments of the invention possible. The drive means may be arranged for application of overreset voltage differences. Application of a reset voltage drive an element from for instance light grey to black. This requires the application of a voltage difference over a certain time period. Overresetting means application of a reset pulse during a longer time period than strictly necessary for achieving the extreme position.

In all of the above examples, the application of the grey scale potential difference, i.e. the grey scale pulse, is bound by the fact that the duration of the grey scale data pulse, the time period T, is an integral number times the frame time. In FIG. 10 this is again shown in detail showing that the reset pulse as well as the driving or grey scale data pulse is an integral number times the frame time, the frame time being indicated in this figure by the vertical lines. In this figure different lengths of reset pulses (12, 8 and 4) are indicated.

Consequently, the number of available grey scales is limited by the frame time resolution. Whilst it is sometimes possible to reduce the frame time by operating the entire system at higher frequencies (at the cost of an increased power dissipation), in general the driving electronics will provide practical limits to how far this is possible (especially maximum operating frequencies of column drivers, charging time of addressing thin film transistors and delay times along addressing lines). In future products with more voltage levels available, the frame time resolution will still limit the number of grey levels available.

The present invention offers an, at least partial, solution for this problem.

FIG. 11 illustrates an embodiment of the invention. The display panel comprises two windows, e.g. the upper half 111 and the lower half 112. during an update period, only one of the windows is addressed, the remainder of the picture element is left unchanged. This is possible with an electrophoretic display panel because the image remains at the not-updated parts of the display providing no electric field is present in the not-updated parts. The frame time may then be halved (from e.g. 20 msec to 10 msec) since the frame time is amongst others determined by the size of the display panel to be addressed and in particular the number of row (or select) electrodes which are addressed. Consequently with the same drive voltage and the same maximum pulse length twice as many grey scales may be obtained.

The embodiment in which a portion is updated is in particular of interest when the image on the display is partitioned, such as is e.g. often the case when web-browsing. When un unpartitioned image is displayed the above method may also be used, but although this method and device are straight forward to implement, it may result in a perception artefact in that a portion, e.g. the top half, of the display will (temporarily) appear to contain more grey levels (i.e. pictures will appear more natural) than the bottom half. In particular, a clear boundary may be apparent in the image between the top and bottom blocks. In order to avoid this problem a different embodiment may be used, as schematically indicated in FIG. 12. In this embodiment the image is partitioned in lines, columns or other small elements (in this examples a number of vertical columns, but it may also be a number of horizontal lines). The display may also be partitioned in a checker board pattern. By addressing in an interlaced manner, e.g. first the even columns and then the odd columns (or first the even lines and then the odd lines, or when use is made of a checker board pattern, first one half of the parts and the other half) the frame time for the odd (even) lines may be halved, with the same result as described above, i.e. an increase in the possible grey levels. Finer interlaced methods (for instance first the lines or columns 1, 4, 7, 10, then the lines or columns 2, 5, 8, 11, then the lines and columns 3, 6, 9, 12 or even finer division, e.g. into four, five or more groups) may be used to further increase the number of possible grey levels.

Devices having drive means arranged for interlaced (or portion-by-portion) application of grey data pulses and the corresponding methods have the great advantage of enabling more grey levels to be obtained. However, a simple, straight forward, application of the invention leads to an improved grey scale but could also lead to a considerable increase in the addressing time for the whole of the image. When only a portion of the image is updated (e.g. only the “active window”) this is not such a great disadvantage and will hardly be perceivable, since the update time for the window is approximately the “normal update time for the display panel as a whole. However, when the whole of the image is updated (a full interlaced update), a straightforward updating of first the even and then the odd columns, lead to a doubling of the update time. Finer interlace methods (three or more subdivisions) would lead to further increase in the update time.

In preferred embodiments of the invention, this disadvantage is for a large or even the major part overcome in that the drive means of the device are arranged to perform a combination of a full, coarse, display update and a “fine tuning” interlaced (or portion-to-portion) update. As described above, the updating only a sub-assembly of the picture element, instead of the whole display, without addressing the remainder of the picture elements is possible with electrophoretic displays because at the not-updated parts of the display (i.e. those picture elements that are not-updated) the previous image will remain in place providing no electric field is present in the not-updated parts, as the effect is bi-stable. When a “coarse” update (corresponding to known methods) is done, this is also the case. For each picture element the grey level will then be either good or nearly good. It is then possible to “fine-tune” the grey levels by application, in an interlaced or portion-by-portion manner of the grey levels.

For example, supposing that the frame time for the full display is 20 msec, and the number of grey levels is 10. Then the update time (considering only the application of the grey scale pulses) would be 20*10=200 msec. This could be taken as the standard time to compare to.

Applying the grey scale pulses in a full interlaced manner would take

for the odd lines, frame time=10 msec, 20 levels, thus 200 msec,

idem for the even lines, thus a total of

200 msec+200 msec=400 msec.

In the alternative method, first the full display would be addressed in the coarse manner, i.e. with a frame time of 20 msec, taking 200 msec. For each picture element the grey level would be either good, or off by one fine unit Thus addressing the odd lines would take 10 msec (application of one fine unit), addressing the even lines would also take 10 msec, for a total of 220 msec (200+2*10), longer than 200 msec, but considerably shorter than 400 msec.

In preferred embodiments an image with more grey scales on substantially the entire display is made, whereby during the image update use is made of both the full frame driving method (with frame time resolution of e.g. 20 msec) for a portion of the image update period, and the partial or interlaced screen update (with frame time resolution of <e.g. 20 msec) for the remainder of the image update period. During the partial screen period, lines are addressed in e.g. an interlaced mode. As an example, the operation could be as follows
Display switches into standard grey level address mode
Information is supplied by the data drivers to all rows in the display at the normal frame time resolution. Pixels requiring a shorter address time than 20 msec are not driven (0V applied to pixel).
The addressing scheme changes and only a subassembly of the rows (e.g. only the even), in the display are addressed. This creates a shorter frame time resolution (e.g. 10 msec). Pixels requiring a shorter refresh time than 20 msec can now be driven
The remaining subassemblies of rows are addressed in subsequent frame periods
If necessary, after these additional frame periods, the addressing scheme changes again and only a smaller subassemblies of the rows in the display are addressed. This creates a still shorter frame time resolution (e.g. 5 msec not shown in a figure). Pixels requiring an even shorter refresh time can now be driven. This scheme may in principle be expanded ad infinitum, to obtain ever better grey scale reproduction. However, there will always be differences between the calculated grey levels (the grey level data) and the actual grey levels, i.e. the grey levels of the picture element. There is little or no use in expanding the scheme beyond difference is grey level that are smaller than such differences or beyond a visible limit.
The remaining subsections of rows are addressed in subsequent frame periods.

At the end of the image update, the display may, if desired, switch back into its normal mode of operation. Such an embodiment is schematically illustrated in FIG. 13. Both subsets 1 and 2 receive common potential difference, i.e. the subsets are commonly addressed with a common grey scale potential voltage difference, followed by a period in which the subset receive separate potential differences, i.e. the subset are separately addressed with a separate grey scale potential difference.

In this example the coarse setting of the grey scales is done before the fine tuning. This is the most straightforward manner of addressing. However, fine-tuning may be done prior to the coarse setting.

In short the invention can be described as follows:

An electrophoretic display panel (1) comprises:

an electrophoretic medium (5) comprising charged particles (6);

a plurality of picture elements (2);

drive means (100).

The drive means (100) are arranged for application of a grey scale potential difference to enable the particles (6) to occupy the position corresponding to the image information (i.e. the grey scale). The drive means are arranged for application of grey scale potential differences during an update period to only a sub-assembly of the picture elements of the display, without addressing the remainder of the picture elements of the display during said update period. More grey scales are obtained.

It will be appreciated by persons skilled in the art that the present invention is not limited by what has been particularly shown and described hereinabove. The invention resides in each and every novel characteristic feature and each and every combination of characteristic features. Reference numerals in the claims do not limit their protective scope. Use of the verb “to comprise” and its conjugations does not exclude the presence of elements other than those stated in the claims. Use of the article “a” or “an” preceding an element does not exclude the presence of a plurality of such elements.

The invention is also embodied in any computer program comprising program code means for performing a method in accordance with the invention when said program is run on a computer as well as in any computer program product comprising program code means stored on a computer readable medium for performing a method in accordance with the invention when said program is run on a computer, as well as any program product comprising program code means for use in display panel in accordance with the invention, for performing the action specific for the invention.

The present invention has been described in terms of specific embodiments, which are illustrative of the invention and not to be construed as limiting. The invention may be implemented in hardware, firmware or software, or in a combination of them. Other embodiments are within the scope of the following claims.

It will be obvious that many variations are possible within the scope of the invention without departing from the scope of the appended claims.

1. An electrophoretic display panel (1), comprising:
an electrophoretic medium (5) comprising charged particles (6);
a plurality of picture elements (2);
electrodes (3,4) associated with each picture element (2) for receiving a potential difference; and
drive means (100),
the drive means (100) being arranged for controlling the potential difference of each picture element (2) to be a grey scale potential difference for enabling the particles (6) to occupy the position corresponding to the image information,
characterized in the drive means are further arranged for application of grey scale potential differences during an update period to only a sub-assembly of the picture elements of the display, without addressing the remainder of the picture elements of the display during said update period.

2. An electrophoretic display panel as claimed in claim 1, characterized in that the drive means are further arranged for application of grey scale potential differences at only a portion of the display, i.e. a specific area of the display.

3. An electrophoretic display panel as claimed in claim 1, characterized in that the drive means are arranged for application of grey scale potential differences in an interlaced manner.

4. An electrophoretic display panel as claimed in claim 1, characterized in that the drive means are arranged for application of a common grey scale potential difference to all of the picture elements to drive each picture element to a position corresponding to or close to a position corresponding to the grey scale data, and for separate application of grey scale potential differences at only a sub-assembly of the picture elements of the display, without addressing the remainder of the picture elements of the display.

5. An electrophoretic display panel as claimed in claim 4, wherein the drive means are arranged for separate application of grey scale potential differences prior to the application of the common grey scale potential difference

6. An electrophoretic display panel as claimed in claim 4, wherein the drive means are arranged for separate application of grey scale potential differences subsequent to the application of the common grey scale potential difference.

7. An electrophoretic display panel as claimed in claim 1, wherein the drive means are arranged for application of preset voltage differences.

8. An electrophoretic display panel as claimed in claim 1, wherein the drive means are arranged for application of a reset potential difference.

9. An electrophoretci display panel as claimed in claim 8, wherein the drive means are arranged for application of an overreset potential difference.

10. A method for driving an electrophoretic display device comprising:
an electrophoretic medium (5) comprising charged particles (6);
a plurality of picture elements (2), in which method grey scale data pulses are applied to elements of the display device during an update period, characterized in that the grey scale data pulses are applied to a sub-assembly of the picture elements, without updating the remainder of the picture elements.

11. A method as claimed in claim 10, characterized in that the grey scale data pulses are applied portion-for-portion of the display panel.

12. A method as claimed in claim 10, characterized in that the grey scale date pulses are applied in an interlaced manner.

13. Drive means (100) for driving an electrophoretic display panel (1), said display panel (1) comprising:
an electrophoretic medium (5) comprising charged particles (6);
a plurality of picture elements (2); and
electrodes (3,4) associated with each picture element (2) for receiving a potential difference;
said drive means (100) being arranged for controlling the potential difference of each picture element (2) to be a grey scale potential difference for enabling the particles (6) to occupy the position corresponding to the image information,
said drive means (100) being further arranged for application of grey scale potential differences during an update period to only a sub-assembly of the picture elements of the display, without addressing the remainder of the picture elements of the display during said update period.
